(19) United States
(12) Patent Application Publication
(10) Pub. No.: US 2007/0003121 A1
(43) Pub. Date: Jan. 4, 2007

(54) Automatic contrast medium control in images

(75) Inventors: Til Aach, Lubeck (DE); Alexandru Condurache, Lubeck (DE); Kai Eck, Aachen (DE); Jorg Bredno, Aachen (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONIC, N.V., EINDHOVEN (NL)

(21) Appl. No.: 10/596,921

(22) PCT Filed: Jan. 6, 2005
(86) PCT No.: PCT/IB05/50077

§ 371 Date: Jun. 29, 2006

(30) Foreign Application Priority Data
Jan. 15, 2004 (EP) 04100119.9

(51) Int. Cl. G06K 9/00

(52) U.S. Cl. 382/130

(57) ABSTRACT

During catheter or guide wire intervention, a road map of, for example, the coronary vessel tree based on pre-interventional angiograms is displayed. This road map, however, is naturally static and hence not consistent with the instantaneous heart and respiration cycles in the life image, which may be displayed on the screen next to the road map. According to an exemplary embodiment of the present invention, images of a series of x-ray images of an object of interest are determined, where the object of interest is not sufficiently filled with the contrast agent. Advantageously, these images may be used to provide for an improved road map.

The present invention relates to the field of digital imaging. In particular, the present invention relates to a method of processing a series of x-ray images of an object of interest, to an image processing device and to a computer program for processing a series of x-ray images of an object of interest.

In diagnostics and therapy of, for example, a coronary heart disease, projection x-ray images acquired in so-called cine imaging mode play a crucial role. To make the coronary arteries visible in such coronary angiographies, a radio-opaque contrast medium is applied by means of a catheter placed, for example in the entrance to a main coronary artery. Pre-interventional coronary angiographic sequences showing the coronary vessel tree during several heart cycles serve as diagnostic images to detect stenoses, and as roadmaps for the intervention itself.

During the intervention, a catheter or a guide wire is advanced under x-ray monitoring through the vessel to the lesion. Only occasional bursts of contrast agent for verification purposes can be given while this procedure is performed. To help navigation, a single frame showing the entire vessel tree filled with contrast agent is therefore selected manually from the pre-interventional angiograms to serve as a roadmap and is displayed on a screen next to the interventional live images. This roadmap, however, is naturally static and is hence not consistent with the instantaneous heart and respiration status in the live images. Due to this, a navigation of the catheter or the guide wire is difficult since the roadmap does not match the interventional image.

It is an object of the present invention to provide for an improved processing of a series of x-ray images of an object of interest, where the object of interest is visible due to a contrast medium.

According to an exemplary embodiment of the present invention as set forth in claim 1, the above object may be solved with a method of processing a series of x-ray images of an object of interest, wherein the object of interest is visible due to a contrast medium, wherein, according to the method, an image of the series of x-ray images where the object of interest is not sufficiently filled with the contrast agent is automatically determined.

Due to this automatic determination, images, for example, of the coronary angiograms can be determined where the vessel tree is sufficiently filled with a contrast agent. Such images may then be preferably displayed as live images, for example, for catheter navigation. However, a couple of images where the vessel tree is sufficiently filled with contrast agent may be overlaid to produce an image where the complete vessel tree is visible. Also, images may be automatically determined where the complete vessel tree is filled with contrast agent.

According to another exemplary embodiment of the present invention as set forth in claim 2, a pre-processing of the images is performed such that a background of the object of interest is at least partially suppressed. Furthermore, enhancement of part of the object of interest may be performed.

According to another exemplary embodiment of the present invention as set forth in claim 3, a morphological filtering is performed and an accentuation of part of the object of interest visible in the respective images of the series of x-ray images is performed on the basis of a motion of the object of interest. Preferably, this may allow for an improved image quality.

According to another exemplary embodiment of the present invention as set forth in claim 4, first and second order derivatives of images are used to enhance image information relating to the object of interest.

Furthermore, this may allow to further improve an image quality such that, for example, in coronary angiograms the vessel tree displayed has an improved image quality.

According to another exemplary embodiment of the present invention as set forth in claim 5, a determination with respect to whether the object of interest is sufficiently filled with contrast agent is performed on the basis of a number of picture elements of the image having a pixel value exceeding a pre-set threshold value.

Advantageously, this allows for a fast and robust determination of images, where the object of interest is sufficiently filled with contrast medium.

According to another exemplary embodiment of the present invention as set forth in claim 6, a determination of the image of the series of x-ray images, where the object of interest is not sufficiently filled with the contrast agent is performed on the basis of a histogram analysis, a feature curve analysis and a feature curve segmentation.

The feature curve segmentation may be based on a maximum likelihood segmentation.

This may allow for a fast, efficient and accurate determination.

According to another exemplary embodiment of the present invention, a 95-percentile of a histogram is used to determine a feature function. Then, a second histogram is formed on the basis of the feature function. Then, a threshold is determined in the second histogram, which separates a first state of an image where the object of interest is insufficiently filled with contrast medium, from a second state of an image where the object of interest is sufficiently filled with the contrast medium.

According to another exemplary embodiment of the present invention, the method is adapted for determining images of coronary angiograms where the vessel tree of the heart is sufficiently filled with contrast agent.

Claim 11 relates to an image-processing device according to another exemplary embodiment of the present invention, which may allow for an improved operation, for example, in conjunction with coronary angiograms and/or catheter navigation.

The present invention relates also to a computer program, for example, to an image-processing device for processing a series of x-ray images of an object of interest. The computer program according to the present invention is defined in claim 12. The computer program according to the present invention is preferably loaded into a working memory of a data processor. The data processor is thus equipped to carry out the method of the invention. The computer program may be stored on a computer program medium such as a CD-ROM. The computer program may also be presented over a network such as the WorldWideWeb, and can be downloaded into the working memory of a data processor from such a network. The computer program may be written in any suitable programming language, such as C++.

In the following, what might be seen as the gist of an exemplary embodiment of the present invention is described with respect to the exemplary identification of complete vessel tree in coronary angiograms. First, a feature map where the vessel regions have been enhanced is created. Then, a vessel enhancement is based on the above observations and vessels are the locally darkest oriented structures with significant motion. A background is then equalized by a morphological top hat transformation with a structuring element comparable to the diameter of the last vessel. Then, a vessel motion is exploited to increase the contrast between background and vessel. Vessel borders are amplified by calculating a gradient norm, while vessel centers—which do not respond to first derivatives—are enhanced by a second derivative operator. The resulting enhanced images can be regarded as containing two classes, namely bright vessels and dark background. It may therefore also serve as a basis for vessel segmentation.

According to an exemplary embodiment of the present invention, a histogram of the enhanced images is determined and the 95-percentile of these histograms is used as a feature. The more area in an image is covered by contrast agent, the higher the 95-percentile. When plotted over time (i.e. the frame number of the images), the feature curve clearly shows the following phases: an in-flow of the contrast agent; a filled state, where the vessel tree is sufficiently filled with contrast agent, and an out-flow, where the contrast agent is washed out of the vessel tree. This feature curve is then segmented.

According to an exemplary embodiment of the present invention, the observations in each of these three states is modeled by a polynomial and then, a segmentation is performed, which allows the best fit of three polynomials as measured by a maximum likelihood criterion.

According to another exemplary embodiment of the present invention, the state sequence is modeled by a Hidden Markov model and is estimated by a maximum a-posteriori (MAP) criterion.

These and other aspects of the present invention will become apparent from and elucidated with reference to the embodiments described hereinafter.

Exemplary embodiments of the present invention will be described in the following, with reference to the following drawings:

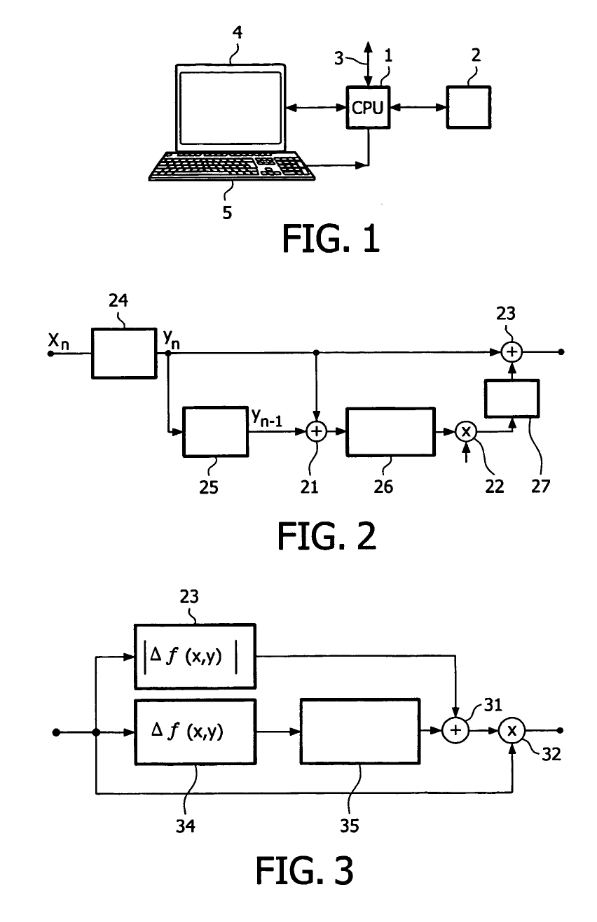

FIG. 1 shows a schematic representation of an image-processing device according to an exemplary embodiment of the present invention, adapted to execute a method according to an exemplary embodiment of the present invention.

FIG. 2 shows a block diagram of a spatio-temporal filtering chain according to an exemplary embodiment of the present invention.

FIG. 3 shows a processing chain with first and second order derivatives as implemented according to an exemplary embodiment of the present invention.

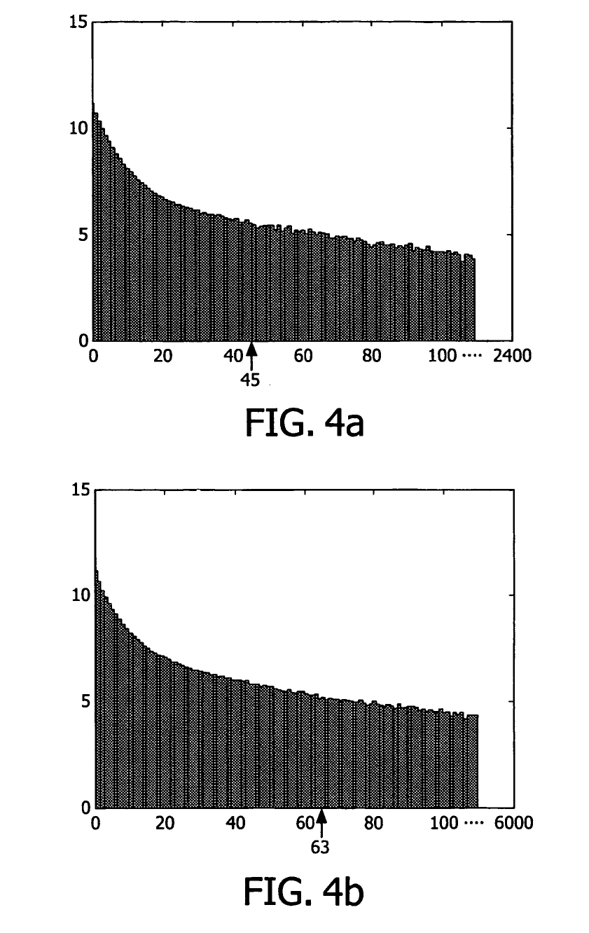

FIG. 4 shows vessel map logarithmic-histograms for an in-flow frame (a) and a filled state (b) according to exemplary embodiments of the present invention.

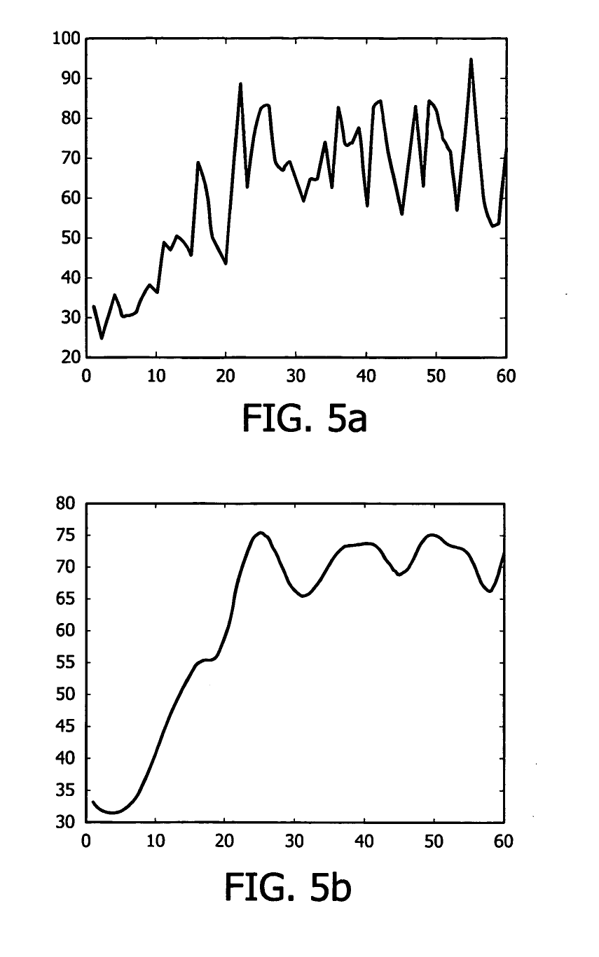

FIG. 5 shows a percentile feature of a frame index (a) filtered by a FIR low pass filter of length 7 (b) according to an exemplary embodiment of the present invention.

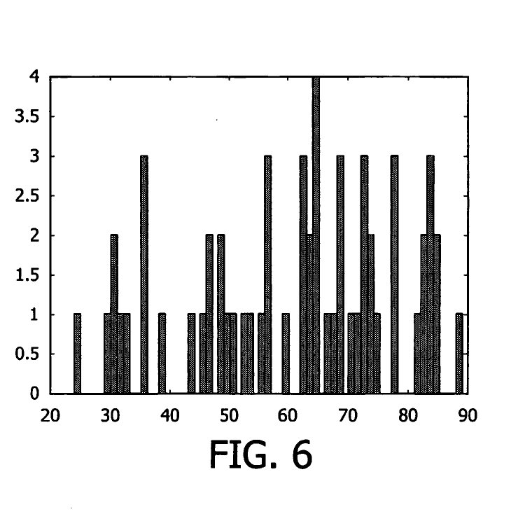

FIG. 6 shows a histogram of the 95-percentile feature curve depicted in FIG. 5b according to an exemplary embodiment of the present invention.

In the following, the present invention will be described with respect to a statistical model based identification of complete vessel tree frames in coronary angiograms. However, it should be noted that the present invention is not limited to this application, but may be applied to any imaging applications where the object of interest is made visible by application of a contrast medium such as x-ray imaging, ultra sonic imaging or MR imaging.

FIG. 1 depicts an exemplary embodiment of an image processing device according to the present invention, for example, executing an exemplary embodiment of the method in accordance with the present invention. The image-processing device depicted in FIG. 1 comprises a central processing unit (CPU) or image processor 1 connected to a memory 2 for storing time series x-ray images. The image processor 1 may be connected to a plurality of input/output network or diagnosis devices, such as an x-ray scanner. The image processor is furthermore connected to a display device 4 (for example, a computer monitor) for displaying information or images computed or adapted in the image processor 1. An operator may interact with the image processor 1 via a keyboard 5 and/or other input/output devices, which are not depicted in FIG. 1.

According to an exemplary embodiment of a method of operating the image processing device depicted in FIG. 1, the image processing device firstly performs a vessel enhancement. The vessel enhancement firstly comprises a morphological filtering and then an exploitation of the motion of the vessel tree. Then, vessel information is enhanced in the angiograms by using first and second order derivatives of the angiograms.

Then, after the vessel enhancement, a histogram analysis and feature curve analysis is performed.

In a next step, feature curve segmentation is performed. The feature curve segmentation may perform maximum likelihood segmentation and/or segmentation on the basis of a Hidden Markov model.

This will be described in further detail in the following:

Vessel Enhancement

Morphological Filtering

A first step towards enhancing vessels with respect to background exploits the property that, being filled by a radio-opaque contrast agent, vessels are locally darker than their immediate surroundings. In order to flatten the varying background intensity, a background image is calculated by removing foreground structures. To this end, a local sliding maximum filter is firstly applied, the dimensions of which are slightly larger than the largest expected vessel diameter. This operation removes locally dark structures, which are smaller than the size of the filter. However, edges of larger dark regions bordering on brighter regions are also eroded, i.e. moved towards the inside of the dark region by approximately the size of the filter. An example of such a region in coronary angiograms is the diaphragm, which usually appears as a dark half disc in the lower portion of the angiograms.

To reconstruct such eroded edges, a local sliding minimum filter of the same size may be applied, which propagates the boundary back to its approximate original location. Maximum and minimum filters may be applied in windows of a pre-determined size and implemented as successive horizontal and vertical 1D filters in order to save complications.

The filtered images then contain almost no foreground information. Subtraction of the original frame from its maximum—and minimum—filtered background version thus leaves the foreground vessel information. The succession of maximum and minimum filtering may be referred to as morphological closing and taking the difference between the original and its closing may be called top hat filter. Due to the maximum filter applied in the first filtering step, the gray level at each pixel in the closing-filtered image is never smaller than the gray level of the same pixel in the original. The gray levels in the top hat filtered image are therefore non-positive.

Exploiting Motion

As has been found out according to the present invention, an additional clue to vessels is their mostly strong and jerky motion, which is caused by the beating heart. When the vessel moves to a new position, absorption at this position will increase due to the contrast agent within the vessel. Therefore, when calculating the pixel-wise difference image between any given frame and its predecessor (or between the current frame and a frame some fixed distance back in time), pixels with the new vessel positions will tend to exhibit negative differences, while the vessel positions in the previous frame will tend to show positive differences. This effect is even more pronounced in top hat filtered angiograms, since the top hat filter reduces background structures, which would cause clutter in the difference images when moving themselves. Therefore, positive values in the difference image are clipped to zero and then, the clipped difference image is added to the current top hat-filtered frame. The overall result is a tendency to make the vessels even darker. Local minima of small extent, which is unlikely to be caused by moving vessels, can optionally be removed by a morphological closing, for example, with a 3×3 structuring element. A block diagram of the processing chain described above is shown in FIG. 2.

The block diagram of the spatio-temporal filtering chain described above is depicted in FIG. 2. Xₙ denotes an n-th incoming angiography frame and Yₙ its top hat filtered version wherein the top hat filtering is performed in top hat filter 24. After subtracting its predecessor Yₙ₋₁ (Yₙ₋₁ is hereby transmitted from z⁻¹-element 25) from Yₙ by means of subtracting element 21, positive differences are clipped towards zero in clipping element 26. After optional weighting by means of weighting element 22 and closing by means of a 3×3 closing element 27, the result is added to Yₙ by means of adding element 23.

First and Second-Order Derivatives

To enhance vessel information in the angiograms after spatio-temporal processing by top hat filtering and motion analysis, a combination of first and second order derivatives may be used to enhance vessel information. Taking a magnitude of the first derivative of the angiograms images evidently captures the steep slopes at the vessel borders, but naturally fails to respond to the flatter portions of the profile within the vessel. Therefore, the first order derivative is complemented by a second-order derivative. Since the second-order derivative captures the middle of the vessel, both derivatives are added to obtain a response over the entire vessel profile.

In a 2D-image f(x, y), the absolute first derivative is replaced by the norm |Δf(x, y)| of the gradient. Gradient information is computed from the eigenvalues λ1 and λ2 of the 2 by 2-tensor T introduced for orientation analysis. Apart from the gradient, the eigensystem of this tensor provides also information on the local structure of the image signal, like orientation, homogeneity and corners. In continuous coordinates, the tensor T is given by
T=∫_{Ω}(∇f)(∇f)^{T}dΩ (1)

where Ω is a small local window. In discrete coordinates, the horizontal and vertical derivatives are first calculated using symmetric finite difference kernels. For the entries along the main diagonal of T, these derivatives are squared, while the entries on the counter-diagonal are given by the pixel-wise product of horizontal and vertical derivatives. Finally, the integration over Ω is realized by a lowpass filter of appropriate size. The gradient norm is then given by the square root of the sum of the eigenvalues, i.e.
|∇f(x,y)|=\sqrt{λ₁(x,y)+λ₂(x,y)} (2)

In addition, the eigenvalues can be used to distinguish three different types of structure: if both eigenvalues are (close to) zero, the local structure in the support window Ω is flat. If the eigenvalue λ1 is large, while the smaller eigenvalue λ2 is (close to) zero, i.e. rank(T)=1, there is a structure with a unique orientation in Ω, caused, e.g., by a locally straight vessel. In this case, the eigenvectors run parallel respectively perpendicular to the orientation. Finally, if both eigenvalues are relatively large, T is not rank-deficient. Then, there is only one local orientation, caused by a sharply bending vessel projection. The gradient norm fails to respond to the vessel middle. Therefore, the gradient norm is complemented by the Laplacian

$$Δ f ( x , y ) = \frac{{\partial }^{2}}{\partial {x}^{2}} f ( x , y ) + \frac{{\partial }^{2}}{\partial {y}^{2}} f ( x , y ) = {f}_{xx} ( x , y ) + {f}_{yy} ( x , y ) \qquad ( 3 )$$

which is linear, shift-invariant and, in its continuous version, isotropic. This operator hence responds to vessel ridges independent of their orientations. As a discrete approximation to the Laplacian operator, a difference of Gaussians (DoG) filter is used, which is an approximation to a combination of the Laplacian with a Gaussian lowpass filter, or so-called Marr-Hildreth operator. The result of filtering the top hat prefiltered image by this operator is added pixel-wise to the gradient-norm image.

Both computation of the gradient norm with a calculation unit 33 via the tensor T and the second derivative with another calculation unit 34 involve lowpass filtering, which is e.g. performed by lowpass filter 35. On the one hand, this makes the processing results more robust with respect to noise, while on the other hand, it blurs vessel edges. The top hat filter, however, preserves edges. In a final step, the sum image, which is provided by adding element 31, is therefore multiplied by the top hat-filtered image by means of multiplier 32 to reduce the blur of the vessel edges. A block diagram of this processing chain is depicted in FIG. 3.

Histogram Analysis and Feature Curve

As found according to the present invention, a presence of contrast agent increases a frequency of occurrence of bright intensity in the vessel map. Therefore, vessel map histograms are analyzed over the time—i.e. frame index—to obtain a time dependent feature curve related to the presence of contrast agent. Since vessels filled by contrast agent cover about 5% of the total image area, as has been found according to the present invention, a 95-percentile of the histograms was chosen as scalar feature. The presence of contrast agent increases tails of the vessel map histograms and thus also the 95-percentile. The three states in-flow, filled state and out-flow are thus visually readily identifiable in the feature function formed over the frame index.

This may be taken from FIGS. 4a and 4b and from FIGS. 5a and 5b. FIGS. 4a and 4b show logarithmic vessel map histograms for an in-flow frame (a) and a filled-state frame (b). Thus, two different states are depicted. It should be noted that the present invention is also applicable for a plurality of states, for example, in a sequence. E.g. an inflow state, a filled state and an outflow state may be determined. The 95-percentile in FIGS. 4a, 4b, 5a and 5b is given by the arrows.

As may be taken from FIGS. 4a and 4b, the 95-percentile in FIG. 4a is approximately 45 and the 95-percentile in FIG. 4b is approximately 63. The abscissae in FIGS. 4a and 4b map the gray values in the image of interest. The ordinates of FIGS. 4a and 4b map the frequency of these gray values. The abscissae in FIGS. 5a and 5b relate to the frame numbers of the images and the ordinates relate to the 95% percentile determined on the basis of a histogram of the preprocessed image as in FIGS. 4a and 4b.

The evolvement of the percentile feature over time is depicted in FIG. 5, where FIG. 5a depicts the percentile feature over the frame index and FIG. 5b shows the same percentile feature over the frame index but filtered by a FIR low pass filter of length 7.

As may be taken from FIGS. 4a and 4b and FIGS. 5a and 5b, two states, in-flow and filled state, are visually readily identifiable. Also, it may be taken from the FIGS. 4a, 4b, 5a and 5b that the area covered by the vessels—and thus the percentile—depends on the heart cycle, since the filled state exhibits a periodic oscillation.

Feature Curve Segmentations

Since each of the states in-flow, filled state and out-flow must form a coherent region, the feature curve as depicted in FIGS. 5a and 5b, but preferably the filtered feature curve depicted in FIG. 5b, is segmented into three regions. For a feature curve of length N, there exists

$$M = ( \begin{matrix}N \\ 2\end{matrix} ) = \frac{N !}{( N - 2 ) ! 2 !} \approx \frac{{N}^{2}}{2} \qquad ( 4 )$$

different segmentations. For a typical length of N=70, one obtains N=2415 possible segmentations.

Maximum Likelihood Segmentation

One possibility to segment the feature curve is by least-squares fitting three polynomials of a given degree to the feature curve. Under Gaussian assumptions, this is equivalent to a Maximum-Likelihood (ML) segmentation. The use of ML-estimation rather than seeking the Maximum a Posteriori (MAP) estimate may be justified by the above strong coherency constraint on the solution. Denoting the succession of states by Q={q₁, . . . ,q_{N}}, where qᵢ is the state label for the ith frame of the angiogram, and the sequence of percentiles by S={s₁, . . . ,s_{N}}, with sᵢ being the percentile observed for the ith angiogram frame, the solution \hat{Q} which obeys

$$\hat{Q} = arg {max}_{Q} p ( S \vert Q ) = arg {max}_{Q} {\prod }_{j = 1}^{3} p ( {s}_{j} \vert {m}_{j} , {σ}_{j}^{2} ) \qquad ( 5 )$$

is sought.

Here, j=1, 2, 3 is the index of region Rⱼ, and sⱼ is a vector with ordered observations in each region. Modeling the observations as Gaussian distributed, mⱼ and σⱼ² are the region-specific parameters of the distribution. Also, the realistic assumption has been made that the observations are region-wise independent. Furthermore, it is assumed that the observations within each region are conditionally independent, i.e. that their dependencies are fully captured by the coherency of the region. Then, for the region likelihood, the following may be obtained:

$$p ( {s}_{j} \vert {m}_{j} , {σ}_{j}^{2} ) = {\prod }_{n ∈ {R}_{j}}^{} p ( {s}_{n} \vert {m}_{j} , {σ}_{j}^{2} ) = {( \frac{1}{\sqrt{2 {πσ}_{j}^{2}}} )}^{{N}_{j}} exp \{ - \frac{1}{2 {σ}_{j}^{2}} {\sum }_{n ∈ {R}_{j}}^{} {( {s}_{n} - {m}_{j} )}^{2} \} \qquad ( 6 )$$

Estimating the unknown region parameters mⱼ and σⱼ² by

$${\hat{m}}_{j} = \frac{1}{{N}_{j}} {\sum }_{n ∈ {R}_{j}}^{} {s}_{j} , {\hat{σ}}_{j}^{2} = \frac{1}{{N}_{j}} {\sum }_{n ∈ {R}_{j}}^{} {( {s}_{j} - {\hat{m}}_{j} )}^{2 } \qquad ( 7 )$$

where Nⱼ is the number of frames in region Rⱼ, and replacing the true parameters by their estimates, Eq. (6) yields

$$p ( {s}_{j} \vert {\hat{m}}_{j} , {\hat{σ}}_{j}^{2} ) = {\sqrt{2 π {\hat{σ}}_{j}^{2}} }^{- {N}_{j}} \cdot {ⅇ}^{- \frac{{N}_{j}}{2}} \qquad ( 8 )$$

Thus, the following equation is used

$$\begin{matrix}\hat{Q} = arg {max}_{Q} [ {\prod }_{j = 1}^{3} p ( {s}_{j} \vert {\hat{m}}_{j} , {\hat{σ}}_{j}^{2} ) ] \\ = arg {max}_{Q} [ {\prod }_{j = 1}^{3} {\sqrt{{\hat{σ}}_{j}^{2}} }^{- {N}_{j}} ] \\ = arg {min}_{Q} {\sum }_{j = 1}^{3} {N}_{j} \cdot log ( {\hat{σ}}_{j}^{2} )\end{matrix} \qquad ( 9 )$$

where all constants and factors not influencing the maximization have been dropped, and where it has been have taken into account that N1+N2+N3=N. Evidently, this formulation seeks the segmentation which permits fitting a polynomial of degree zero optimally—i.e. with minimum mean square error as defined by Eq. (7)—to each region.

An alternative is to segment such that a polynomial of degree one can be fit best to each region. Then, each region mean mⱼ is replaced by the slope aⱼ and the mean bⱼ, and the likelihood for each region becomes

$$p ( {s}_{j} \vert {a}_{j} , {b}_{j} {σ}_{j}^{2} ) = {( \frac{1}{\sqrt{2 {πσ}_{j}^{2}}} )}^{{N}_{j}} exp \{ - \frac{1}{2 {σ}_{j}^{2}} {\sum }_{n ∈ {R}_{j}}^{} {( {s}_{n} - {a}_{j} n - {b}_{j} )}^{2} \} \qquad ( 10 )$$

With the estimates

$${\hat{σ}}_{j}^{2} = \frac{1}{{N}_{j}} {\sum }_{n ∈ {R}_{j}}^{} {( {s}_{n} - n {\hat{a}}_{j} - {\hat{b}}_{j} )}^{2} \qquad ( 11 )$$

one again gets

$$p ( {s}_{j} \vert {\hat{a}}_{j} , {\hat{b}}_{j} , {\hat{σ}}_{j}^{2} ) = {\sqrt{2 π {\hat{σ}}_{j}^{2}} }^{- {N}_{j}} \cdot {ⅇ}^{- \frac{{N}_{j}}{2}} \qquad ( 12 )$$

The parameters âⱼ and \hat{b}ⱼ are estimated by minimizing \hat{σ}ⱼ²:

$$\begin{matrix}\frac{\partial }{\partial {\hat{b}}_{j}} {\hat{σ}}_{j}^{2} = 0 ⇒ {\sum }_{n ∈ {R}_{j}} {s}_{n} = {\hat{a}}_{j} {\sum }_{n ∈ {R}_{j}} n + {N}_{j} {\hat{b}}_{j} & ( 13 ) \\ \frac{\partial }{\partial {\hat{a}}_{j}} {\hat{σ}}_{j}^{2} = 0 ⇒ {\sum }_{n ∈ {R}_{j}} n {s}_{n} = {\hat{a}}_{j} {\sum }_{n ∈ {R}_{j}} {n}^{2} + {\hat{b}}_{j} {\sum }_{n ∈ {R}_{j}} n & ( 14 )\end{matrix}$$

These equations, which must be solved for âⱼ and \hat{b}ⱼ, can be decoupled when centering the region-internal coordinate n such that

$${\sum }_{n ∈ {R}_{j}} n = 0 \qquad ( 15 )$$

This yields

$${\hat{b}}_{j} = \frac{1}{{N}_{j}} {\sum }_{n ∈ {R}_{j}} {s}_{n} , {\hat{a}}_{j} = \frac{{\sum }_{n ∈ {R}_{j}} n {s}_{n}}{{\sum }_{n ∈ {R}_{j}} {n}^{2}} \qquad ( 16 )$$

The sought segmentation is then given by

$$\hat{Q} = arg {min}_{Q} {\sum }_{j = 1}^{3} {N}_{j} \cdot log ( {\hat{σ}}_{j}^{2} ) \qquad ( 17 )$$

For fitting polynomials of degree two, it may be switched to a matrix notation. With the fitting error
eₙ=sₙ−aⱼn²−bⱼn−cⱼ=sₙ−[n²,n,1]·[aⱼ,bⱼ,cⱼ]^{T} (18)

for region Rⱼ may be obtained

$$\begin{matrix}{e}_{j} = {s}_{j} - {M}_{j} {b}_{j} \\ where & ( 19 ) \\ {e}_{j} = [ \begin{matrix}{e}_{1} \\ {e}_{2} \\ ⋮ \\ {e}_{{N}_{j}}\end{matrix} ] , {M}_{j} = [ \begin{matrix}{n}_{1}^{2} & {n}_{1} & 1 \\ ⋮ & ⋮ & ⋮ \\ {n}_{{N}_{j}}^{2} & {n}_{{N}_{j}} & 1\end{matrix} ] , {b}_{j} = [ \begin{matrix}{a}_{j} \\ {b}_{j} \\ {c}_{j}\end{matrix} ] & ( 20 )\end{matrix}$$

The variance estimate is then

$${\hat{σ}}_{j}^{2} = \frac{1}{{N}_{j}} {e}_{j}^{T} {e}_{j} \qquad ( 21 )$$

and, minimizing \hat{σ}ⱼ² by the estimate \hat{b}ⱼ of the parameter vector, it may be found

$$\frac{\partial {\hat{σ}}_{j}^{2}}{\partial {\hat{b}}_{j}} = 0 ⇒ {\hat{b}}_{j} = {( {M}_{j}^{T} {M}_{j} )}^{( - 1 )} {M}_{j}^{T} {s}_{j} = {[ {\hat{a}}_{j} , {\hat{b}}_{j} , {\hat{c}}_{j} ]}^{T} \qquad ( 22 )$$

The criterion to optimize is again given by Eq. (17), with the variance estimate given by Eq. (21). Extension to polynomials of higher degree is obvious.

For each segmentation, the optimal fit can thus be determined. The ML-segmentation is the one with minimum optimal fitting error. Since the number of possible segmentations is limited by the coherency constraint (Eq. (4)), full search is practically feasible.

Segmentation by a Hidden-Markov Model

The Hidden Markov model (HMM) describes a random state sequence, which can only be observed through another random process conditioned on it. In the above case, the observable random process is the 95-percentile computed from the vessel map histograms. The underlying, hidden process is modeled as a two-state sequence, which indicates whether or not the coronary vessel tree in an angiography frame is fully filled by contrast agent. It should be noted that sequences with a plurality of states, e.g. 3 or more, may also be modeled. The HMM is then parameterized by
the 2×2 state transition probability matrix A=[aᵢⱼ]
the probability density functions (pdf) pk(s), k=1, 2, of the observations conditioned on the states, and
the initial state probability vector II=[π₁,π₂]

Thus, the optimum state sequence Q subject to the MAP criterion is determined, i.e. such that P(Q|S) is maximum. To estimate the conditional pdfs p₁(s) and p₂(s), it is assumed that the histogram of the feature curve consists of two Gaussian densities. This histogram is thresholded by Otsu's algorithm such that the separability between the two classes is maximized. An example histogram is shown in FIG. 6. From this initial histogram, the threshold is found to 57. Once hard thresholding is carried out, mean and variance of the conditional pdfs as well as prior state probabilities π₁ and π₂ can be estimated.

The a priori knowledge is now predominantly expressed via the state transition matrix A, with the transition probabilities such that staying in the current state is strongly encouraged. Empirically, A was determined as

$$A = [ \begin{matrix}0.7 & 0.3 \\ 0.3 & 0.7\end{matrix} ] \qquad ( 23 )$$

Two different optimization algorithms were implemented: the first approach uses the Viterbi algorithm to optimize over all possible state sequences, without considering the coherency constraint. The probability for assigning a certain sequence of labels Q=(q₁,q₂ . . . ,q_{N}) to a certain sequence of frames I₁,I₂ . . . ,I_{N} is

$$p ( Q ) = {\prod }_{i = 2 … N} p ( {q}_{i} ) \cdot p ( {q}_{i - 1} -> {q}_{i} )$$

with q∈{i,f}, i denoting inflow and f denoting filled state. p(qᵢ) is the probability of frame Iᵢ being of the state qᵢ as given by the pdf that are assigning probabilities to percentile values (coming from Otsu's method applied to the percentile histograms).

The transition probabilities

$$p ( {q}_{i - 1} -> {q}_{i} ) = \{ \begin{matrix}0.7 \\ 0.3\end{matrix} for \begin{matrix}{q}_{i} = {q}_{i - 1} \\ {q}_{i} \neq {q}_{i - 1}\end{matrix}$$

are given by the transition probability matrix A.

The computations are on the order of 4N. The coherency constraint is brought to bear afterwards by finding the state sequence consistent with the coherency constraint which is closest in Hamming-distance to the solution found by the Viterbi algorithm. The second option proceeds similar as done for the above Maximum-Likelihood approach by carrying out a full search over all possible sequences consistent with the coherency constraint. Here, the N²/2 different sequences need to be tested. In practice, both optimization methods gave very similar results. Note, however, that the Viterbi-based approach is more flexible when the coherency constraint is violated, e.g.

by giving several bursts of contrast agent.

Advantageously, the above described method and image processing device allow for an identification of complete vessel tree frames in coronary angiograms in an automatic manner. Furthermore, the above described method and operation may be applied to other applications, where objects, preferably moving objects of interest are imaged by a time series of images where the object of interest is visible due to a contrast medium.

1. Method of processing a series of x-ray images of an object of interest, wherein the object of interest is visible due to a contrast medium, the method comprising the step of:
automatically determining an image of the series of x-ray images where the object of interest is not sufficiently filled with the contrast medium.

2. The method of claim 1, further comprising the steps of:
enhancing parts of the object of interest visible in respective images of the series of x-ray images;
preprocessing the respective images of the series of time series x-ray images such that a background of the object of interest is at least partly suppressed.

3. The method of claim 2, further comprising the steps of
performing a morphological filtering; and
performing an accentuation of parts of the object of interest visible in the respective image of the series of x-ray images on the basis of a motion of the object of interest.

4. The method of claim 2, further comprising the steps of:
enhancing image information relating to the object of interest on the basis of first and second order derivatives of the respective image of the series of x-ray images.

5. The method of claim 1,
wherein a determination of the image of the series of x-ray images where the object of interest is not sufficiently filled with the contrast medium is performed on the basis of a number of picture elements of the image having a value exceeding a preset threshold value.

6. The method of claim 1,
wherein a determination of the image of the series of x-ray images where the object of interest is not sufficiently filled with the contrast medium is performed on the basis of a histogram analysis, a feature curve analysis and a feature curve segmentation.

7. The method of claim 6,
wherein the feature curve segmentation is performed by using a maximum likelihood segmentation.

8. The method of claim 1,
wherein the series of x-ray images is a time series of x-ray images;
wherein first histograms of the time series of x-ray images are analyzed over the time to obtain a time dependent feature curve related to a presence of contrast medium in the object of interest;
wherein a 95 percentile of the first histograms is used to determine a feature function;
wherein a second histogram is formed of the feature function;
wherein a threshold is determined in the second histogram which separates a first state of an image where the object of interest is filled insufficiently with the contrast medium from a second state of an image where the object of interest is sufficiently filled with the contrast medium; and
wherein a transition matrix is determined for describing a probability that the first state changes to the second state.

9. The method of claim 8,
wherein the second histogram is modeled by means of a plurality of Gaussian distribution density functions such that a probability is determined for values of the 95-percentile relating to whether the respective values belong to the first state or the second state.

10. The method of claim 1, wherein the method is for determining images of coronary angiograms where the vessel tree of the heart is sufficiently filled with contrast medium.

11. Image processing device, comprising:
a memory for storing a series of x-ray images of an object of interest wherein the object of interest is visible due to a contrast medium; and
an image processor for processing the series of x-ray images of the object of interest, wherein the image processor is adapted to perform the following operation:
automatically determining an image of the series of x-ray images where the object of interest is not sufficiently filled with the contrast medium.

12. Computer program for processing a series of x-ray images of an object of interest wherein the object of interest is visible due to a contrast medium, wherein the computer program is adapted to cause a processor to perform the following operation when the computer program is executed on the processor:
automatically determining an image of the series of x-ray images where the object of interest is not sufficiently filled with the contrast medium.
